(19) United States
(12) Patent Application Publication
(10) Pub. No.: US 2009/0257136 A1
(43) Pub. Date: Oct. 15, 2009

(54) IMAGE MAGNIFYING DEVICE FOR PORTABLE MULTIMEDIA PLAYER

(76) Inventor: KENG-YUAN LIU, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/100,892

(22) Filed: Apr. 10, 2008

(51) Int. Cl. G02B 27/02

(52) U.S. Cl. 359/802; 359/804

(57) ABSTRACT

An image magnifying device for portable multimedia player includes a connection mechanism having an insertion slot formed on one side thereof; a supporting unit including a base defining a central opening corresponding to the insertion slot for setting around the insertion slot on the connection mechanism, and two supporting arms movably connected at lower ends to two lateral sides of the base; and a magnifying unit including a frame being movably connected at two lateral sides to upper ends of the two supporting arms, and a magnifier fixed in the frame. When a portable multimedia player is inserted in the insertion slot, image shown on a display screen of the portable multimedia player is magnified by the magnifier located in front of the display screen, allowing a user to clearly view the magnified image.

### FIELD OF THE INVENTION

The present invention relates to an image magnifying device for portable multimedia player, and more particularly to an image magnifying device having a magnifying unit for magnifying an image shown on a display screen of a portable multimedia player, so that a user may clearly view the magnified image.

### BACKGROUND OF THE INVENTION

The currently available portable multimedia player generally includes a case, a central processing unit mounted in the case, and a storage unit, a power supply unit, a display screen, and a plurality of control keys electrically connected to the central processing unit. The display screen and the plurality of control keys are externally located at on the case. With these arrangements, a user may conveniently carry the portable multimedia player about for playing back music and image at any time and at any place.

The portable multimedia player is not only characterized by its function of playing sounds and images, but also by its compactness and light weight, which enables a user to conveniently carry the portable multimedia player about. To enable a compact and light-weight portable multimedia player, the size of the display screen on the player is inevitable reduced. As a result, the image shown on the small-size display screen has lowered definition and tends to hazard the user's eyes.

### SUMMARY OF THE INVENTION

A primary object of the present invention is to provide an image magnifying device, to which a portable multimedia player may be connected, so that an image shown on the portable multimedia player may be magnified for a user to view clearly.

To achieve the above and other objects, the image magnifying device for portable multimedia player according to the present invention includes a connection mechanism having an insertion slot formed on one side thereof; a supporting unit including a base defining a central opening corresponding to the insertion slot for setting around the insertion slot on the connection mechanism, and two supporting arms movably connected at lower ends to two lateral sides of the base; and a magnifying unit including a frame being movably connected at two lateral sides to upper ends of the two supporting arms, and a magnifier fixed in the frame.

When a portable multimedia player is inserted in the insertion slot, image shown on a display screen of the portable multimedia player is magnified by the magnifier located in front of the display screen, allowing a user to clearly view the magnified image.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an image magnifying device for portable multimedia player according to a preferred embodiment of the present invention;

FIG. 2 is an assembled view of FIG. 1;

FIG. 3 shows the connection of a portable multimedia player to the image magnifying device of the present invention;

FIG. 4 shows the image magnifying device of the present invention with the portable multimedia player connected thereto; and

FIG. 5 is a side view showing the adjustment of the image magnifying device of the present invention to different angular position for viewing.

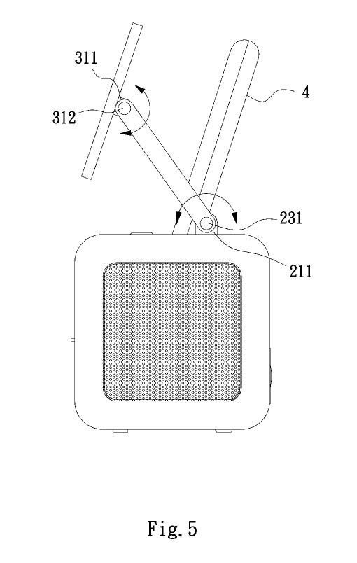

### DETAILED DESCRIPTION OF THE PREFERRED EMBODIMENTS

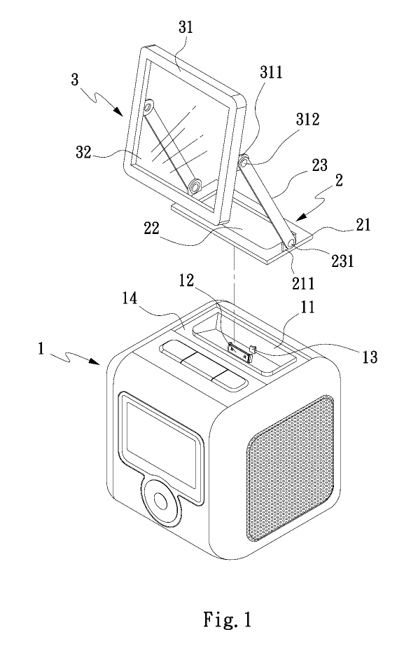

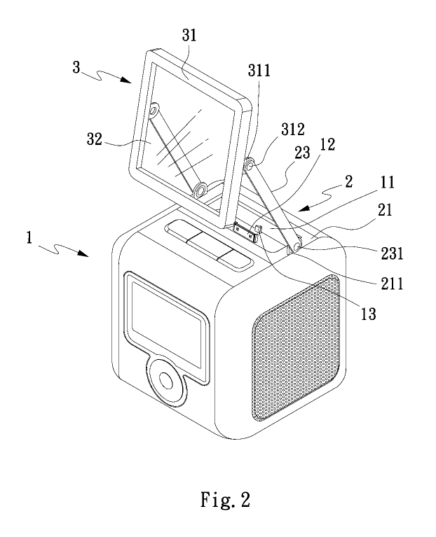

Please refer to FIGS. 1 and 2 that are exploded and assembled perspective views, respectively, of an image magnifying device for portable multimedia player according to a preferred embodiment of the present invention. As shown, the present invention includes a connection mechanism 1, a supporting unit 2, and a magnifying unit 3.

The connection mechanism 1 may be an adapter, a player, or a charger, and is provided on one side with at least an insertion slot 11. A connector 12 is provided in the insertion slot 11, and an engaging head 13 is projected from one side wall of the insertion slot 11. And, a recess area 14 is formed around an outer side of the insertion slot 11.

The supporting unit 2 includes a base 21 and two supporting arms 23. The base 21 defines a central opening 22 corresponding to the insertion slot 11, so that the base may be set in the recess area 14 to surround the insertion slot 11 and locate on the connection mechanism 1. The base is provided at two lateral sides with a lug 211 each. The two supporting arms 23 are pivotally turnably connected at respective lower ends to the lugs 211 via a pivot pin 231 each.

The magnifying unit 3 includes a frame 31 and a magnifier 32 fixed in the frame 31. The frame 31 is provided at two lateral sides with a lug 311 each. The two supporting arms 23 are pivotally turnably connected at respective upper ends to the lugs 311 via a pivot pin 312 each, so that the magnifying unit 3 is movably connected to the supporting unit 2.

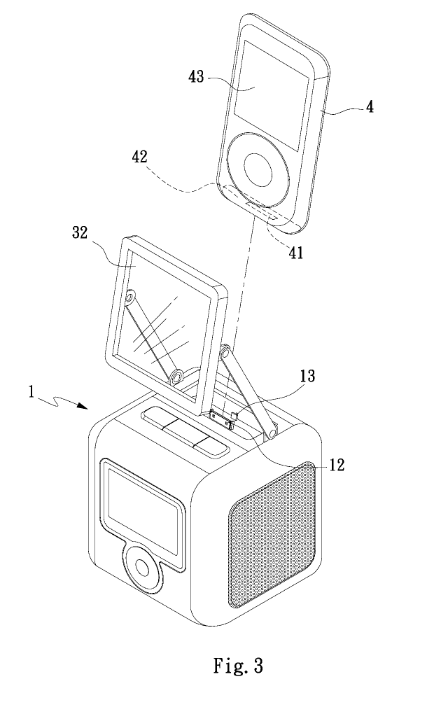

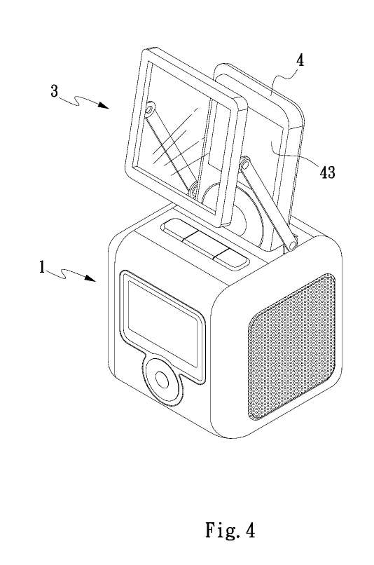

Please refer to FIGS. 3 and 4 that show the connection of a portable multimedia player 4 to the image magnifying device of the present invention. To do so, simply position the portable multimedia player 4 in the insertion slot 11 on the connection mechanism 1 with a mating connector 41 on the portable multimedia player 4 engaged with the connector 12 in the insertion slot 11, so that the portable multimedia player 4 is electrically connected to and cooperates with the connection mechanism 1 to perform related functions, such as transmitting audio/video signals, playing sounds and music, and/or charging the portable multimedia player 4.

The portable multimedia player 4 is provided with an engaging recess 42 for receiving the projected engaging head 13 formed in the insertion slot 11, so that the portable multimedia player 4 positioned in the insertion slot 11 may be securely held to the connection mechanism 1. At this point, the magnifier 32 of the magnifying unit 3 is located in front of a display screen 43 on the portable multimedia player 4. Therefore, images shown on the display screen 43 may be magnified by the magnifier 32 of the magnifying unit 3 for a user to watch clearly.

When viewing the image played on the display screen 43 of the portable multimedia player 4, the user may adjust the magnifying unit 3 according to personal height, view angle, and environmental conditions, such as reflected or refracted light, so that the magnifier 32 is set to an angular position best for magnifying the images. To do so, the user needs only to apply a force against the magnifying unit 3 for the supporting arms 23 to pivotally turn about the pivot pins 231, 312 relatively to the lugs 211, 311, respectively, until the magnifying unit 3 is located at a desired angular position relative to the display screen 43 of the portable multimedia player 4.

With the image magnifying device of the present invention, the portable multimedia player 4 may be set on the connection mechanism 1 to locate behind the magnifier 32, allowing a user to clearly watch a magnified image being displayed by the portable multimedia player. Therefore, the present invention is improved and practical for use.

1. An image magnifying device for portable multimedia player, comprising:
a connection mechanism being provided on one side with an insertion slot;
a supporting unit being set on the side of the connection mechanism having the insertion slot, and including a base defining a central opening corresponding to the insertion slot and at least one supporting arm movably connected at a lower end to one lateral side of the base, wherein the supporting unit is detachable from the connection mechanism;
a magnifying unit being movably connected to the supporting unit, and including a frame movably connected at one side to an upper end of the supporting arm and a magnifier fixed in the frame; and
wherein the base of the supporting unit having a peripheral dimension substantially equal to a peripheral dimension of a iPod dock adapter.

2. The image magnifying device for portable multimedia player as claimed in claim 1, wherein the connection mechanism is selected from the group consisting of an adapter, a player, and a charger.

3. The image magnifying device for portable multimedia player as claimed in claim 1, wherein the insertion slot on the connection mechanism is provided at a predetermined position with a connector and on a side wall surface with a projected engaging head; and a recess area being formed on the connection mechanism surrounding an outer side of the insertion slot.

4. The image magnifying device for portable multimedia player as claimed in claim 1, wherein the base of the supporting unit is provided on at least one lateral side with a first lug, and the supporting arm of the supporting unit being pivotally turnably connected at the lower end to the first lug via a pivot pin.

5. The image magnifying device for portable multimedia player as claimed in claim 1, wherein the frame of the magnifying unit is provided on at least one lateral side with a second lug, and the supporting arm of the supporting unit being pivotally turnably connected at the upper end to the second lug via a pivot pin.
